(19) United States
(12) Patent Application Publication
(10) Pub. No.: US 2009/0027221 A1
(43) Pub. Date: Jan. 29, 2009

(54) SENSOR SYSTEM AND METHOD FOR DETERMINING THE WEIGHT AND/OR POSITION OF A SEAT OCCUPANT

(75) Inventor: Thomas Plocher, Sulz (DE)

Correspondence Address: LEYDIG VOIT & MAYER, LTD, 700 THIRTEENTH ST. NW, SUITE 300, WASHINGTON, DC, 20005-3960, US

(73) Assignee: BAG BIZERBA AUTOMOTIVE GMBH, Balingen (DE)

(21) Appl. No.: 12/175,580

(22) Filed: Jul. 18, 2008

(30) Foreign Application Priority Data
Jul. 23, 2007 (DE) 10 2007 035 924.3

(51) Int. Cl. G08B 21/22

(52) U.S. Cl. 340/667

(57) ABSTRACT

A sensor system for determining the weight and/or position of a seat occupant, comprising at least two spaced-apart weight force sensors which provide measured weight force signals, and a control device which generates a signal characterising the weight and/or the position of a seat occupant, on the basis of the measured weight force signals, is provided, wherein the control device has a time analysis device, by means of which the time course of a measured weight force signal of at least one weight force sensor can be analysed and which provides time analysis data.

The present disclosure relates to the subject matter disclosed in German application number 10 2007 035 924.3 of Jul. 23, 2007, which is incorporated herein by reference in its entirety and for all purposes.

### BACKGROUND OF THE INVENTION

The invention relates to a sensor system for determining the weight and/or position of a seat occupant, comprising at least two spaced-apart weight force sensors, which provide measured weight force signals, and a control device, which generates a signal characterising the weight and/or the position of a seat occupant on the basis of the measured weight force signals.

The invention also relates to a method for determining the weight and/or position of a seat occupant, in which measured weight force signals from at least two spaced-apart weight force sensors are evaluated.

Vehicles comprise airbags to prevent serious injury in the event of collisions. It is advantageous, in this case, if the deployment force of an airbag is controlled. The measurement of the weight of a seat occupant in the vehicle provides data with which the deployment force can be controlled. An airbag should not be triggered, or should be triggered at a low deployment force if a relatively light person (compared with an average adult) or a small child is sitting on a vehicle seat. The weight information and/or the position information about the seat occupant can be used to classify the seat occupant and thereby to control the deployment force.

EP 1 299 269 B1 discloses a method for classifying seated vehicle occupants using a plurality of weight force sensors within a vehicle seat.

EP 1 028 867 B1 discloses a method for determining the factors in conjunction with a seat occupant in a vehicle to control the reaction of a safety restraint system. A plurality of spaced-apart weight force sensors is used which are associated with the vehicle seat. The centre of gravity is used to determine a correction factor which represents the ratio of the total weight of a seat occupant to the weight acting on the seat if a seat occupant is sitting on the seat. The actual weight of the seat occupant is calculated by multiplying the total weight acting on the vehicle seat by the correction factor.

DE 38 09 074 C2 discloses a safety system for a vehicle, which comprises four sensors to determine the sitting position of a seat occupant.

US 2005/0090959 A1 discloses a sensor structure with sensors, which are arranged within a seat structure to measure the weight of the seat occupant. The sensors may be arranged in any one of a plurality of sensor configurations. To use common hardware with different sensor configurations, a virtual matrix is provided and output signals of the sensors are mapped into the virtual matrix. The virtual matrix comprises virtual cell positions, which have no corresponding sensor output signal; fewer physical cells (sensors) are present than virtual cell positions in the virtual matrix. A weight output signal is mapped into the corresponding position in the virtual matrix and the remaining virtual cell positions have associated values based on the data, which are provided by the surrounding physical cells. The seat occupant weight is determined on the basis of an output from the virtual matrix and the seat occupant is placed in one of a plurality of seat occupant classifications. The deployment force of a restraint system is controlled according to the classification of the seat occupant.

Further weight classification systems are described in U.S. Pat. No. 6,070,115 A, U.S. Pat. No. 6,801,111 B1, U.S. Pat. No. 6,243,634 B1 and U.S. Pat. No. 7,024,295 B2.

DE 10 2004 046 305 A1 discloses a restraint system for a motor vehicle with a restraining belt and with a belt buckle holder, which is rigidly connected to the body of the motor vehicle. The belt buckle holder has a force sensor for measuring the tension of the restraining belt and an evaluation circuit which is suitable for evaluating the tension signal detected by the force sensor with respect to heart and/or breathing activities.

DE 10 2005 020 847 A1 discloses a method for the contactless detection of vital functions and for determining the spatial position of the heart or other significant body parts in the body interior of the passengers of a motor vehicle.

EP 0 842 060 discloses an arrangement for recognising the type of occupancy of a vehicle seat, which has at least one sensor means which reacts to the movements of an occupant or object occupying the vehicle seat, which sensor means divide the sensor output signal in a frequency-selective manner into a plurality of signal fractions.

A pressure sensor for biological information which has a planar form and is arranged on an elastic support element for supporting a human body, is known from DE 10 2006 035 447 A1. The sensor is used to detect an external force on the basis of a load change, which is caused by the human body, and/or a vibration, which is produced by the human body.

A mechanism for detecting the presence of people, preferably on seats, is known from DE 43 22 159 A1, an electric monitoring arrangement being associated with the people. Electrodes are used to scan the human body.

A device for the classification of occupants of a motor vehicle is known from DE 103 05 978 A1 and has a weight detection mechanism coupled to a seat mechanism. A control unit carries out the classification of the occupants as a reaction to the weight signal and an acceleration signal by tracking a display of the frequency range of the weight signal divided by the acceleration signal.

A presence detection mechanism of a vehicle, which has a vibration sensor located in a vehicle seat, is disclosed in DE 693 15 869 T2. A presence decision means assesses whether the human body is present on the seat or not in that it distinguishes between the person or another object in agreement with the frequency properties, which have been detected by the detection means.

### SUMMARY OF THE INVENTION

In accordance with the present invention, a sensor system is provided, which is constructed in a simple manner and with which precise results can be obtained.

In accordance with an embodiment of the invention, the control device has a time analysis device, by means of which the time course of a measured weight force signal of at least one weight force sensor can be analysed and which provides time analysis data.

In accordance with the invention, not only does the at least one weight force sensor provide a signal characterising the weight force acting on the respective weight force sensor but additional time analysis data are provided. It can be checked by means of the additional time analysis data whether the weight force sensors are working correctly. Furthermore, it is possible, in particular if less than four weight force sensors are present, to obtain additional information to precisely determine the weight and/or the sitting position of a seat occupant even with this reduced number of weight force sensors. It is furthermore possible to determine by means of the additional time analysis whether a person or an object is positioned on a seat; for example, the heartbeat or the breathing can be recognised by a corresponding frequency in a frequency spectrum.

The time analysis data, in particular, contain information about the frequency and/or signal strength. IF, for example, a frequency analysis is carried out, the time analysis data contain information about the frequency or frequencies contained and/or about the signal strength of the corresponding frequency signals.

For example, it is possible to recognise, using the time analysis data, whether the seat occupant is a child or an adult or a young person. Children generally have a higher pulse frequency than adults. If a child seat is arranged on a seat, it is to be expected that the signal strength of a physiological frequency signal is low or a corresponding frequency signal can no longer be detected.

By using the solution according to the invention, it is possible, under some circumstances, to dispense with an additional belt force sensor.

The sensor system according to the invention can be used particularly advantageously if one or more weight force sensors which are not present as hardware are simulated by one or more virtual weight force sensors. A corresponding sensor system and a corresponding method are described in the EP application 07 101 282.7, which is not published prior art, dated 26 Jan. 2007 (Applicant Bizerba GmbH & Co. KG).

The spatial position of the control device is basically arbitrary in this case. The control device can be arranged as a separate unit on the seat. It may be arranged partially or completely on one or more weight force sensors. It is also possible for the control device to be completely or partially integrated in a control device of a restraint system of a vehicle and, for example, integrated in an airbag ECU.

It is favourable if the time analysis device has a frequency converter which generates a frequency spectrum for a measured weight force signal. A corresponding frequency analysis can then be carried out on the frequency spectrum. The peaks in the frequency spectrum can be evaluated with respect to position (frequency value) and level (signal strength). The frequency converter, for example, generates the frequency spectrum by Fourier analysis.

It is advantageous if the time analysis device comprises a filter which filters out frequencies about a limit frequency. This allows frequencies which are not relevant for the evaluation to be filtered out. In particular, a targeted analysis can then be carried out with regard to physiological frequencies which are in an order of magnitude of 1 Hz. The breathing frequency is about 0.15 Hz and the heartbeat frequency about 1.5 Hz.

It is favourable if the limit frequency is at most 30 Hz and in particular at most 20 Hz.

Advantageously, the presence of physiological frequencies in the measured weight force signal of the at least one weight force sensor can be checked with the time analysis device. If a corresponding peak in the frequency spectrum in the order of magnitude of 1 Hz (in the range of, for example, about 0.1 Hz to 2 Hz) is found in the time analysis, this indicates that a person and not an object is sitting on the seat. The heartbeat or the breathing can basically be recognised by a time analysis.

It is favourable if the control device comprises a classification device which provides seat occupation classification data with regard to the weight and/or position of a seat occupant. Corresponding classification data can be provided directly to an airbag controller in order to control the deployment on the basis of these data.

It is favourable if the time analysis device is connected to the classification device and provides it with time analysis data. The time analysis data can be used for classification to achieve more precise classification.

It is furthermore advantageous if the control device comprises a plausibility checking device, to which time analysis data are provided. If, for example, different weight force sensors have very different frequency spectra, this indicates a malfunction. Such malfunctions can be detected by the plausibility checking device.

A data processing device is favourably provided, which combines weight force signals of a plurality of weight force sensors. This allows the total weight of a person sitting on a seat to be detected with the aid of a finite number of weight force sensors (with at least two weight force sensors), even if only a partial weight of this person is detected by an individual weight force sensor. Furthermore, a sitting position can be determined.

It is favourable if at least one filter device, by means of which the data processing device can be provided with weight force signals which are time-independent or at most change slowly with respect to time, is associated with the data processing device. Evaluation or processing of data at the data processing device thus takes place substantially on time-independent weight force signals or on weight force signals, which can be regarded as “quasi stationary”. The time analysis data can then additionally be used in the solution according to the invention.

It is favourable if the time analysis device provides the data processing device with time analysis data so it can optionally use the time analysis data. It is possible, for example, that if a plurality of weight force sensors are provided, a physiological frequency can only be recognised in one weight force sensor. This indicates that the centre of gravity of the seat occupant is located close to this weight force sensor. This information can then be used for a more precise determination of the total weight or the sitting position.

It may be provided that the time analysis device comprises a switching device, by means of which a switch can be made with regard to whether a classification device and/or a plausibility checking device and/or a data processing device and/or one or more virtual weight force sensors can be provided with time analysis data. Which units of the control device are supplied with time analysis data can be controlled by means of the switching device.

In an advantageous embodiment, at least one virtual weight force sensor is provided, the virtual weight force signals of which are determined on the basis of measured weight force signals of at least two weight force sensors, the position of a seat occupant being determined on the basis of measured weight force signals and virtual weight force signals. A sensor system of this type is described in the EP application 07 101 282.7 dated 26 Jan. 2007, to which reference is expressly made. At least two weight force sensors are provided as hardware and at least one weight force sensor is a weight force sensor which is not implemented as hardware and which is simulated. The number of weight force sensors in the system implemented as hardware can thus be reduced without the determination of the weight and/or the position of a seat occupant being impaired. The corresponding sensor system manages with less weight force sensors implemented as hardware and can therefore be produced more economically, is easier to install and has a higher degree of security against failure.

It is also possible to check a weight force sensor implemented as hardware with regard to malfunction with an associated simulated virtual weight force sensor. Too great a deviation between a virtual weight force signal and an actual weight force signal indicates a malfunction of the weight force sensor implemented as hardware.

The at least one virtual weight force sensor in the control device is implemented as software, in particular. It is “provided” by calculation methods.

It is possible, in this case, for the at least one virtual weight force sensor to replace or supplement a hardware weight force sensor. In the first case, the number of actually necessary hardware weight force sensors can be reduced. In the latter case, a weight force sensor implemented as hardware can be monitored by means of an associated virtual weight force sensor for malfunctions.

In particular, time analysis data are provided to the at least one virtual weight force sensor. This allows a higher degree of accuracy to be achieved with regard to the weight determination and/or sitting position determination of a seat occupant on the basis of virtual weight force signals.

In particular, the weight force sensors are, in this case, arranged on the corners of a polygon and the at least one virtual weight force sensor is associated with a polygon corner. As a result, the weight and/or the sitting position of a seat occupant can easily be determined.

It is favourable if a data processing device is provided to calculate the spatial centre of gravity of the measured weight force signals. A calculation method (calculation mode) according to which a virtual weight force sensor is simulated, can be selected with the aid of the spatial centre of gravity thus determined of the measured weight force signals (which does not have to be the mass centre of gravity of a seat occupant). As a function of the selected calculation method, the virtual weight force signals are then provided. It is possible, therefore, for example, to determine the weight or the position of a seat occupant with only two or three weight force sensors implemented as hardware. Reference is made, in this case, to the application EP 07 101 282.7 dated 26 Jan. 2007 which is not published prior art.

The sum of the measured weight force signals and the virtual weight force signals is determined, in particular, by the data processing device. This produces the total weight.

The sensor system according to the invention can be positioned in an easy and advantageous manner in a seat and, in particular, a vehicle seat.

It is particularly favourable if the sensor system is arranged on a seat face; the sensor system may, in this case, be integrated in a corresponding seat region in order to easily determine weight force data which are caused by a seat occupation.

In accordance with the present invention, a method is provided, by means of which control data for a vehicle restraint system can be provided in a simple and precise manner.

In accordance with an embodiment of the invention, in addition to the evaluation of measured weight force variables, a time analysis of measured weight force signals is carried out and time analysis data are taken into account when calculating the weight and/or position of a seat occupant and/or the measured weight force signals are checked for plausibility with the aid of the time analysis data.

The method according to the invention has the advantages which have already been described in conjunction with the sensor system according to the invention.

Further advantageous configurations have also been described already in conjunction with the sensor system according to the invention.

It is favourable if, during the time analysis, a frequency analysis is carried out with regard to the physiological frequencies. For example, an analysis is carried out as to whether a frequency is present in a frequency spectrum, which is typical of a heartbeat or breathing. It can thus be seen, for example, whether a person or an object is sitting on the seat. Furthermore, under some circumstances, detailed seat occupation information can be obtained. For example, it can be distinguished whether the seat occupant is a child or a young person. If a child seat is arranged on the seat, no further frequency signal can be detected or the frequency signal is at least greatly weakened. Furthermore, the position of the frequency itself shows whether a child or an adult is the seat occupant, as children generally have a higher pulse than adults.

It is favourable if a frequency analysis is carried out with respect to frequencies below a limit frequency. Frequencies above the determined limit frequency are than not further investigated.

In particular, the limit frequency is at most 30 Hz and preferably at most 20 Hz. This allows typical physiological frequencies in the order of magnitude of 1 Hz to be recognised and analysed.

It is favourable if virtual weight force signals are calculated from measured weight force signals, at least one virtual weight force sensor being simulated by virtual weight force signals. This allows the number of required weight force sensors implemented as hardware to be reduced or weight force sensors implemented as hardware can be monitored for malfunctions.

The weight and/or the position of a seat occupant is calculated using the measured weight force signals and the virtual weight force signals. For this purpose, the procedure may be as follows: a centre of gravity of these weight force signals is determined from the measured weight force signals. This centre of gravity is not necessarily the mass centre of gravity of the vehicle occupant. A virtual weight force signal is then calculated. For this purpose, a defined calculation mode is selected on the basis of the spatial position of the centre of gravity of the measured weight force signals and is then used to determine the virtual weight force signals. The measured weight force signals and the virtual weight force signals which belong together (i.e. which belong to the same instant or the same time interval) are then added up. The sum produces the total weight determined.

In particular, a seat occupation classification is carried out with the aid of the time analysis data. During a seat occupation classification, the measured signals are evaluated in such a way that a grouping into a finite number of quantity elements is carried out. For example, five different classes are provided for the seat occupation. If, in addition, time analysis data are used, the precision of the classification can be improved.

It may also be provided that the time analysis data are used for the simulation of the at least one virtual weight force sensor Under some circumstances an improved simulation result is thereby achieved, i.e. the virtual weight force signal only deviates slightly or not at all from a weight force sensor implemented as hardware, at the same point.

It may also be provided that the measured weight force signals are checked for plausibility by means of the time analysis data. If, for example, deviations, which are too great, are found in the frequency spectrum of different weight force signals, this indicates a malfunction and, in particular, systematic malfunction.

The following description of preferred embodiments is used in conjunction with the drawings for a more detailed description of the invention.

### BRIEF DESCRIPTION OF THE DRAWINGS

FIG. 1 shows a schematic view of a seat, which is provided with an embodiment of a sensor system according to the invention;

FIG. 2 shows a schematic view of a weight force sensor, which is fitted to a seat fastening element and to a seat element;

FIG. 3 shows a schematic view of an embodiment of a sensor system according to the invention;

FIG. 4 shows a schematic diagram, which shows intermediate steps for calculating virtual weight force signals;

FIG. 5 shows a diagram showing various calculation modes for various sub-fields if a virtual weight force sensor BR according to FIG. 3 is simulated by a weight force sensor BL;

FIG. 6 shows a diagram when, in a corresponding sub-field, the virtual weight force sensor BR according to FIG. 3 is simulated by the sensor FL; and

FIG. 7 shows a schematic block diagram of an embodiment of a sensor system according to the invention with a detailed view of a control device.

### DETAILED DESCRIPTION OF THE INVENTION

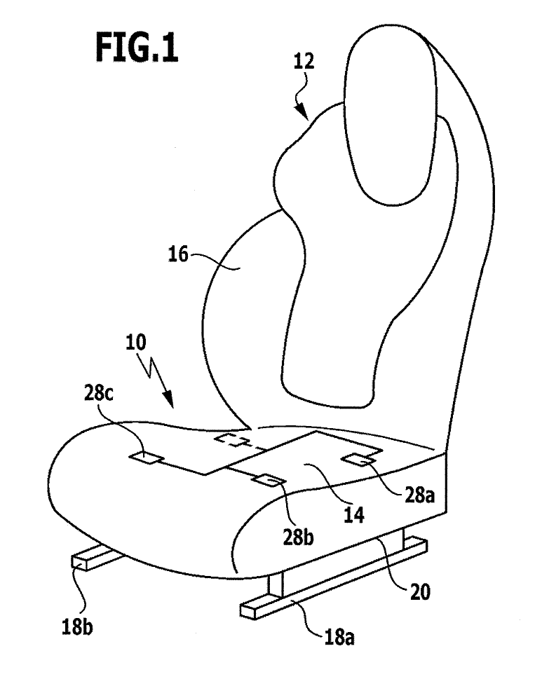

An embodiment of a sensor system according to the invention, which is shown in FIGS. 1, 3 and 7 and designated there by 10, serves for use on a seat 12. The seat 12 is, in particular, a vehicle seat, which is fitted to a vehicle. The vehicle comprises a restraint system which comprises an airbag associated with the seat 12. The restraint system may comprise further components such as a restraining belt with a belt buckle holder, one or more sensors, for example to measure the tension of the restraining belt, being arranged on the belt buckle holder.

The seat 12 has a seat face 14, on which a seat occupant is sitting and a backrest 16. The sensor system 10 is associated with the seat face 14.

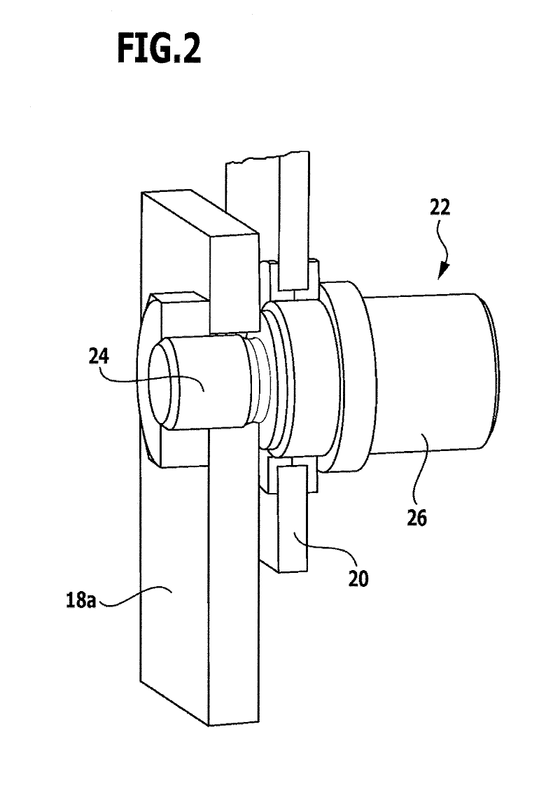

The vehicle comprises seat fastening elements 18a, 18b for fixing the seat 12 to the vehicle. The seat fastening elements 18a, 18b are, for example, fastening rails. The seat 12 comprises corresponding seat elements 20, by means of which the seat 12 can be fixed to the seat fastening elements 18a, 18b. The fixing of the seat 12 to the seat fastening elements 18a, 18b, in one embodiment, takes place by means of weight force sensors 22 (FIG. 2) of the sensor system 10.

The weight force sensors 22 provide measured force signals and, in particular, measured weight force signals. It is, in this case, basically possible for a weight force sensor to be constructed such that forces (in particular weight forces) are directly measured. It is also possible for a weight force sensor to indirectly measure the forces exerted. For example, pressure sensors can be used as weight force sensors which measure effectively acting pressures, from which the acting forces are then derived.

An embodiment of a weight force sensor 22 comprises a first part 24 and a second part 26, which can be moved relative to one another. The first part 24 is fixed to the seat fastening elements 18a, 18b. The second part 26 is fixed to the seat element 20. The weight force sensors 22 measure the force exerted. This force is brought about by the weight of the seat 12 and a seat occupant sitting on it. (In this case, the weight of the seat occupant does not have to be entered completely as he is supported, for example, by his feet on a vehicle floor.) The weight force sensor 22 provides corresponding measured weight force signals, a single weight force sensor not measuring the weight of the seat occupant, but a part weight (weight fraction).

For example, a weight force sensor 22 has a pin-shaped configuration. Examples of weight force sensors are described in WO 2006/092325, WO 2006/105902, EP 1 742 029 or in WO 2007/006364.

In a further embodiment, the weight force sensors of the sensor system 10 are integrated into the seat face 14. For example, the weight force sensors 22 are connected to a mat-like structure, which is arranged inside a region below the seat face 14.

The sensor system 10 comprises different weight force sensors 28a, 28b, 28c, for example of the type 22 described above. At least two weight force sensors are provided. The weight force sensors 28a, 28b, 28c, which are implemented as hardware, are arranged spaced apart from one another, so that adjacent weight force sensors are distanced from one another. They are arranged in such a way that the weight of a seat occupant and/or the position of the seat occupant on the seat 12 can be determined.

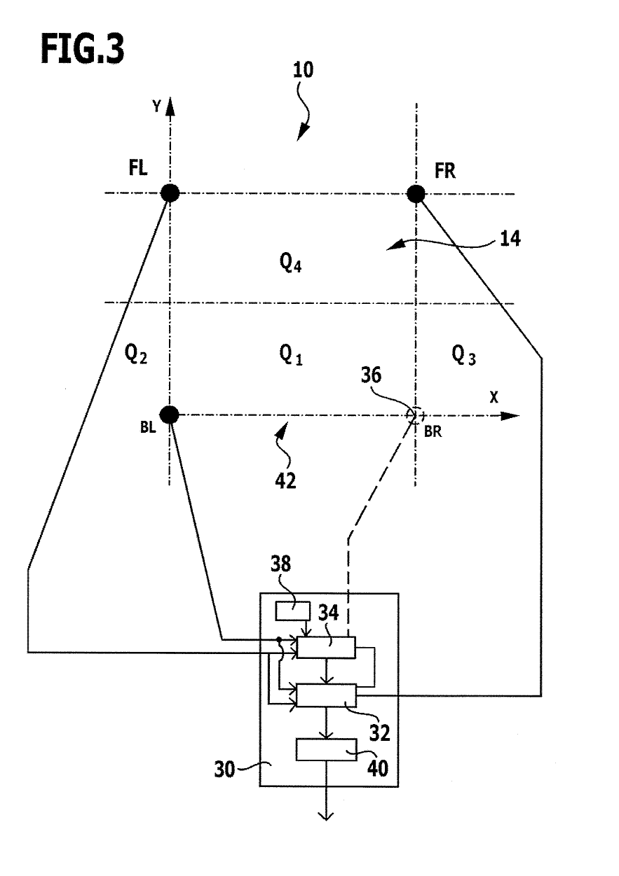

As indicated in FIG. 3, the sensor system 10, in a specific embodiment, comprises a weight force sensor FL (front left) of the type 22, a weight force sensor FR (front right) and a weight force sensor BL (back left). The rear positions are adjacent to the backrest 16. The sensors FL, FR, BL are arranged on the corners of a polygon such as, for example, a rectangle. A projection of the polygon onto the seat face 14 is located within the seat face 14. The x-direction and y-direction in FIG. 3 give the extending directions of the seat face 14. The gravitational direction is perpendicular to the x-direction and perpendicular to the y-direction (and therefore perpendicular to the plane of the drawing according to FIG. 3).

The weight force sensors may be arranged at the same level relative to one another based on the gravitational direction or different sensors may be arranged at different levels.

Depending on the structure of the seat 12 and/or the weight and/or the position of the seat-occupant, the force, which is exerted on the sensors FL, FR and BL may be different.

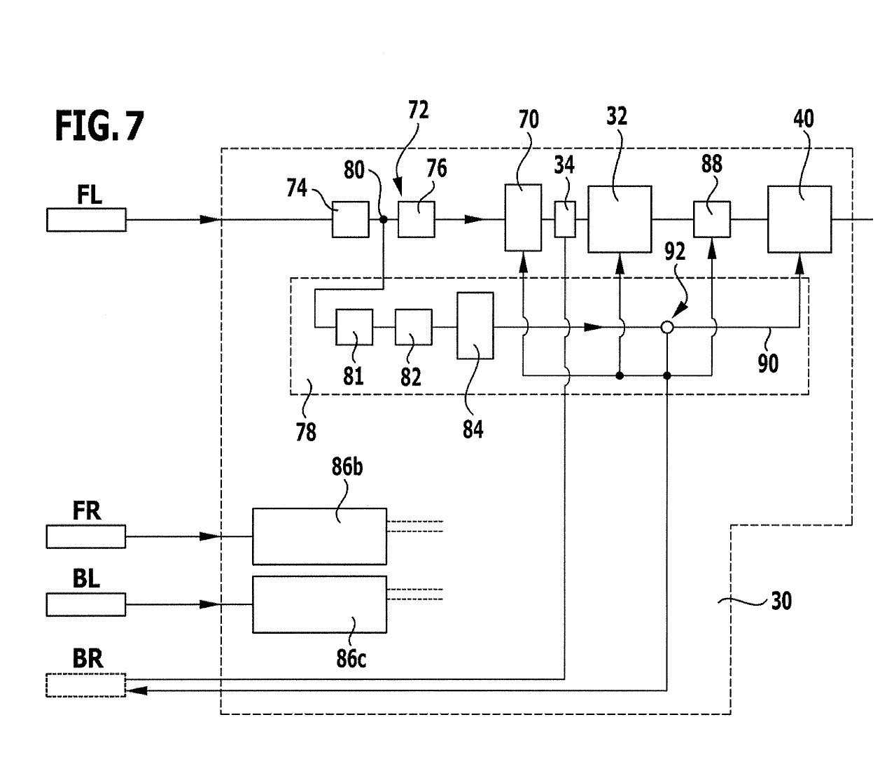

The sensor system comprises a control device 30 (FIGS. 3 and 7). In FIG. 7, the control device is shown in more detail. The control device may, in this case, be separate from the weight force sensors FL, FR and BL. For example, the control device 30 is then an external mechanism, which is arranged outside sensor housings of the weight force sensors. In an alternative embodiment, the control device 30 is integrated into one or more weight force sensors FL, FR and BL. The control device 30 or parts of the control device 30 are then arranged inside a sensor housing of the corresponding weight force sensor or the corresponding weight force sensors or they may be connected to a sensor housing. In an embodiment of this type, a weight force sensor or a plurality of weight force sensors with an integrated control device or integrated parts of the control device 30 can also carry out data evaluation processes and/or signal evaluation processes.

The weight force sensors FL, FR and BL are connected to the control device by means of corresponding signal lines. The signal lines may in this case be parts of a bus system such as, for example, a field bus system.

If the control device 30 is distributed over a plurality of weight force sensors 22 and integrated in weight force sensors, different calculation tasks and/or evaluation tasks may be allocated to different weight force sensors with the corresponding control device part.

The weight force sensors FL, FR and BL are implemented as hardware and provide measured weight force signals to the control device 30. The control device 30 comprises a data processing device 32. The latter processes the measured weight force signals and evaluates them.

It may be provided in this case that a plausibility checking device 70 is associated with the data processing device 32 and in particular connected upstream thereof (FIG. 7). This can be used to check whether the measured weight force signals are plausible. If a negative result is achieved here, a corresponding signal, such as, for example, a warning signal, can be emitted. The data processing device 32 and the plausibility checking device 70 of the control device 30 are associated in this case with all the weight force sensors FL, FR, BL.

A filter device 72 is associated with the respective weight force sensor 28a, 28b, 28c. This is used to provide the data processing device 32 with processed weight force signals, which do not change with respect to time or only slowly (“quasi stationary”) and, in particular, do not change periodically. The filter device 72, for example, comprises a first filter 74, which is used for filtering out signal peaks which are limited with respect to time. Such signal peaks which are limited with respect to time are produced in particular by jolts, which a vehicle experiences, for example when it drives over a pothole. The filter device 72 furthermore comprises a second filter 76 connected downstream of the first filter 74, which second filter is configured as a low-pass filter and at most allows weight force signals through which change slowly with respect to time.

A time analysis device 78 is associated with each weight force sensor 28a, 28b, 28c. The respective time analysis device 78 is connected to a data path 80 of the corresponding weight force sensor, which is located upstream of the data processing device 32. The signals, which are processed in the time analysis device 78 are branched off upstream of the second filter 76.

The time analysis device 78 comprises a frequency converter 81, which generates a frequency spectrum from the time-dependent measured weight force signal processed by means of the first filter 74. For example, the frequency converter 81 is configured as a Fourier analyser, which generates the frequency spectrum by Fourier analysis (for example by means of fast Fourier transformation). A filter 82, which is configured, in particular, as a low-pass filter, is connected downstream of the frequency converter 81. The filter 82 is used to filter out higher frequencies above a frequency limit value. Typically, the limit frequency value is below about 30 Hz and, for example, below 20 Hz. Non-physiological frequencies are to be filtered out by the low-pass filter 82. Physiological frequencies in relation to a seat occupant are, for example, the breathing frequency or heart frequency in the range of about 0.1 Hz to 2 Hz.

The time analysis device 78 has a sampling rate, the frequency of which is significantly greater than the limit frequency. For example, the sampling rate is about 1 kHz. The corresponding “low-frequency” signals can thereby be detected with good resolution.

The time analysis device 78 furthermore comprises an analysis unit 84 which is connected downstream of the low-pass filter 82 and generates a time analysis signal which can be used for further evaluation. The time analysis signal contains information about whether one or more specific frequencies and in particular physiological frequencies were contained in the corresponding measured weight force signals or not.

A filtering device 72 and a time analysis device 78 are also associated with the other weight force sensors, (such as, for example, FR and BL). This is indicated in FIG. 7 by the elements with the reference numerals 86b, 86c.

It is, in this case, basically also possible for the control device 30 to only comprise a single filter device 72 and/or a single time analysis device 78, to which all weight force sensors 28a. 28b, 28c then provide their signals for processing and time analysis.

In the sensor system according to the invention, in addition to the evaluation of the weight force signals with regard to their absolute value after passing through the filter device 72, which makes these weight force signals substantially independent of time, the time course thereof and in particular a possible periodic fraction is evaluated by means of the time analysis device 78.

The control device 30 comprises a unit 34, which simulates at least one virtual weight force sensor. In the embodiment according to FIG. 3, the simulated virtual weight force sensor is the sensor BR at a position 36. A virtual weight force sensor is not implemented as hardware, but only as software. The virtual weight force sensor emits virtual weight force signals. The virtual weight force sensor BR is embedded in the control device 30. A virtual weight force sensor BR, for example, replaces a weight force sensor 22 implemented as hardware at the position 36 of the polygon, the position 36 being a corner, which is not taken up by the weight force sensors FL, FR and BL implemented as hardware.

The virtual weight force sensor BR is a replacement for a hardware weight force sensor at the position 36. At this position 36, the seat 12 is fixed to the corresponding seat fastening element 18a or 18b with a suitable fastening mechanism. The fastening mechanism is for example a pin, a screw or a weld connection.

The unit 34 provides virtual weight force sensor signals, which are not measurement signals and are also not processed measurement signals. The virtual weight force signals are calculated on the basis of the measured weight force signals of at least one of the weight force sensors FL, FR or BL. For this purpose at least one of the weight force sensors FL, FR and BL is connected to the unit 34 in order to be able to provide measured weight force sensor signals.

(In the embodiment according to FIG. 3, the weight force sensors FL and BL provide their measurement signals to the unit 34.)

The unit 34 calculates the virtual weight force signals on the basis of data stored in a data base 38 of the control device 30. The stored data may, for example, be values in table form or stored functions or stored algorithms. The stored functions are, in particular, interpolation functions.

The database 38 stores data, in particular, which correspond to different calculation modes for virtual weight force signals. Advantageously, different calculation modes are provided for different occupation situations of the seat 12.

The data processing device 32 can be used to determine the spatial centre of gravity of the measured weight force signals of the weight force sensors FL, FR and BL. If the spatial centre of gravity of the measured weight indications is known, this information can be used to select a special calculation mode to calculate virtual weight force signals.

The spatial centre of gravity of the weight force sensor signals is, in this case, not the mass centre of gravity for the seat 12 with a seat occupant, but an intermediate variable, which is required for further processing of the data.

With the calculated virtual weight force signals and the measured weight force signals, which are provided by the weight force sensors FL, FR and BL, the data processing device 32 can calculate weight data and/or position data for the seat occupant. In particular, the data processing device 32 adds up the measured weight force signals of the weight force sensors FL, FR and BL and the virtual weight force signal of the virtual weight force sensor BR.

The control device 30 furthermore comprises a classification device 40, which calculates seat occupation classification data from the data provided by the data processing device 32, said classification data characterising the weight and/or the position of the seat occupant. In particular, the classification device 40 provides weight data to an airbag control device.

A filtering device 88 may be arranged between the data processing device 32 and the classification device 40. This, for example, allows the formation of an average value and/or plausibility checking to be carried out.

The classification data may be comprised, in this case, by a classification data set. A finite number of data elements is then provided. In a specific embodiment, the data set has five data elements for the classification of the weight of a seat occupant and a further sixth data element is provided to indicate a malfunction.

In the embodiment according to FIG. 3, three weight force sensors implemented as hardware are provided and one virtual weight force sensor implemented as software. It is also possible for, for example, two weight force sensors implemented as hardware to be provided or for more than three weight force sensors implemented as hardware to be provided. Furthermore, it is also possible for more than one virtual weight force sensor to be present.

In a specific embodiment, the position 36 for a virtual weight force sensor is selected in such a way that the corresponding position on the seat face 14 is a position which is subject to the least forces in comparison to other positions. However, it is also possible for the position 36 to be a position which is not subject to the least forces in comparison to other positions.

The weight and/or the position of a seat occupant is determined as follows:

The weight force sensors FL, FR and BL provide their measured weight force signals after processing by the filter device 72 to the data processing device 32 and are processed there. The data processing device 32 calculates the spatial centre of gravity of the measured weight force signals as follows:

$$\vec{c} = {\sum }_{i = 1}^{n} {\vec{r}}_{i} S ( i ) / {\sum }_{i = 1}^{n} S ( i ) ; \qquad ( 1 ) ;$$

\vec{r}ᵢ is, in this case, the vector of the position of the weight force sensor i implemented as hardware and S(i) is the measured weight force signal (optionally after processing) of the weight force sensor i. The sum is a function of the number n of weight force sensors implemented as hardware, which contribute measured weight force signals.

In the embodiment according to FIG. 3, the centre of gravity of the measured weight force signals is calculated as follows:

$$\vec{c} = ( \begin{matrix}S ( FR ) \\ S ( FL ) + S ( FR )\end{matrix} ) \frac{1}{S ( FL ) + S ( FR ) + S ( BL )} , \qquad ( 2 )$$

wherein the position of the weight force sensor BL is used as the origin.

The vector \vec{C} has an X-component and a Y-component.

A spatial data field 42 is associated with the sensor system 10 and the seat face 14. This data field 42 is divided into sub-fields Q₁, Q₂, Q₃, Q₄ etc.

The spatial centre of gravity of the measured weight force signals is located in one of the sub-fields, this actual sub-field in which the spatial centre of gravity is located, depending on the seat occupation, specifically on the weight of the seat occupant and/or on the position of the seat occupant. The unit 34 selects the calculation mode for the virtual weight force signals to be calculated as a function of into which sub-field (Q₁ or Q₂ or Q₃ or Q₄) the spatial centre of gravity of the measured weight force signals falls.

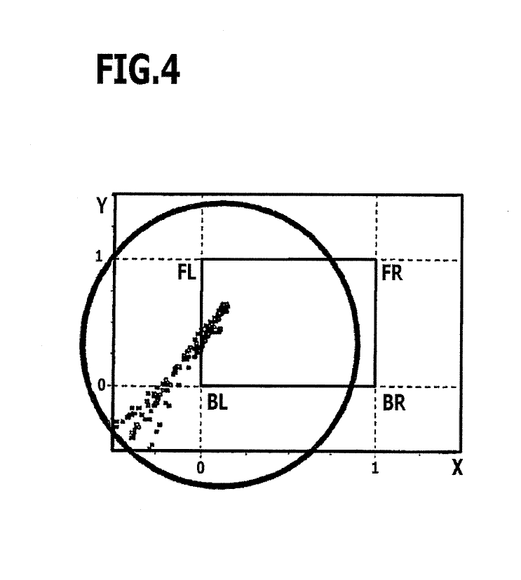

FIG. 4 shows a diagram of calculated spatial centres of gravity of the measured weight force signals for various seat occupation conditions in the embodiment according to FIG. 3. It can be seen that the centre of gravity of the weight force signals can be located in different positions in relation to the weight force sensors FL, FR, BL implemented as hardware.

The calculation mode for the virtual weight force signals is based on predetermined data The predetermined data are, in particular, specific to the seat 12. These data have been determined in advance, for example, as values in table form or as interpolation functions and stored in the database 38. The predetermined data have, in particular, been predetermined in such a way that no step is present when the limit of adjacent sub-fields is exceeded. In particular, there is a constant transition when a limit is exceeded.

The polygon, for example, on the corners of which the weight force sensors FL, FR and BL implemented as hardware are located and on the further corner of which the virtual weight force sensor BR is virtually arranged, is divided into two sub-fields Q₁ and Q₄ of the same size. The sub-field Q₁ comprises a corner, on which the weight force sensor BL implemented as hardware is arranged, and a corner, on which the virtual weight force sensor BR is virtually arranged. The sub-field Q₄ comprises a corner, on which the weight force sensor FL is actually arranged and a corner on which the weight force sensor FR is actually arranged.

To the left of the sub-field Q₁ is arranged a sub-field Q₂ and to the right of the sub-field Q₁ is arranged a sub-field Q₃.

In a specific embodiment, virtual weight force signals from the virtual weight force sensor BR are used on the basis of the measured weight force signals from the weight force sensor BL if the spatial centre of gravity of the measured weight force signals falls in the sub-fields Q₁ or Q₂ or Q₃. The calculation mode for Q₁, Q₂ and Q₃ is different, however.

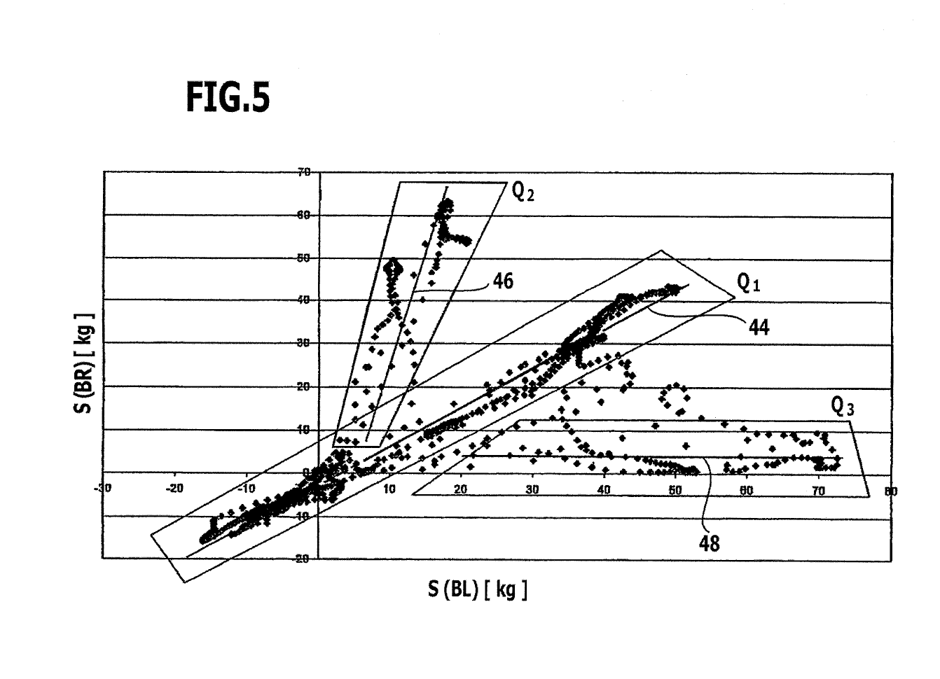

FIG. 5 shows measurement values (points), if, instead of the virtual weight force sensor BR, a weight force sensor implemented as hardware is used. A measurement of this type is carried out as a type of calibration measurement in order to determine the data for the calculation modes. It can be seen from FIG. 5 that the sub-fields Q₁, Q₂ and Q₃ have different characteristics.

Interpolation functions 44, 46, 48 are then determined from the measured data. These functions depend on the sub-field. They are stored in the database 38. The interpolation functions 44, 46, 48 are, for example, multipolynomial interpolation functions.

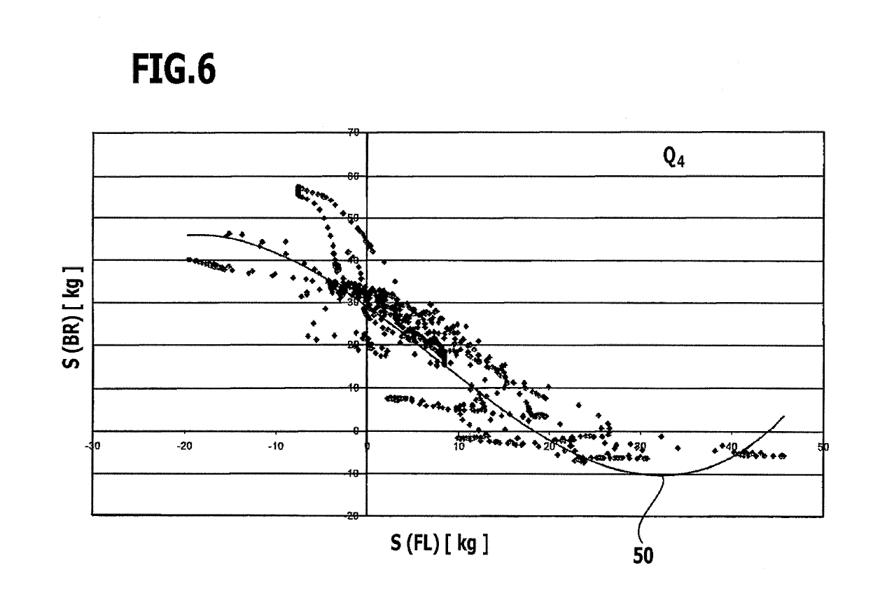

FIG. 6 shows the measured data (points) if a weight force sensor implemented as hardware is used instead of the virtual weight force sensor BR and an interpolation function 50. The interpolation function 50 is a rough approximation. Better approximations can be used, if necessary.

If the weight or the position of a seat occupant of the seat 12 is determined by the sensor system 10, only the functions 44, 46, 48, 50 are used. The unit 34 calculates the virtual weight force signals S (BR)=f(\vec{C}) using the functions 44, 46, 48, 50. Which function is used depends on in which sub-field (Q₁, Q₂, Q₃ or Q₄), the spatial centre of gravity of the measured weight force signals falls.

After calculation of the virtual weight force signals, the unit 34 provides the data processing device 32 with these results. The data processing device 32 combines the measured weight force sensor signals (after processing by the filter device 72) and the virtual weight force signals, which belong together. In particular, the data processing device 32 provides a total signal Σ=S(BR)+S(FL)+S(FR)+S(BL). This signal characterises the weight of the seat occupant.

The classification device 34 converts this weight force signal into classification data, which can be provided to an airbag control device.

The sensor system 10 comprises at least two spaced-apart weight force sensors 22. Using measured weight force signals of at least one of these weight force sensors implemented as hardware, virtual weight force signals can be calculated. This allows a virtual weight force sensor to be simulated, the actually measured weight data being used as a basis for the simulation. The virtual weight force sensor does not provide any measured weight force signals, but virtual weight force signals, based on calculations.

The manner in which the virtual weight force signals are calculated depends on where the centre of gravity of the measured weight force signals from weight force sensors implemented as hardware is located.

A small number of weight force sensors can thus be used to determine, for example, the weight of a seat occupant. For example, two or three weight force sensors are sufficient to determine the weight of a seat occupant. “Missing” weight force sensors are simulated as software by one or more virtual weight force sensors in the control device 30. The sensor system 10 can thus be implemented in an economical manner. It can be produced and fitted easily. In addition, it can be maintained in a simple manner and it works more reliably.

It is, in this case, basically possible for a weight force sensor if implemented as hardware and a virtual weight force sensor to be located at the same position. The sensor implemented as hardware is physically located there and the virtual weight force sensor is simulated at this position, i.e. positioned there virtually. Thus, the weight force sensor implemented as hardware can be monitored for malfunction and the like by means of the virtual weight force signals.

It is provided in the solution according to the invention that the time analysis data provided by the time analysis device 78 are also used for evaluation. These analysis data are provided to the classification device 40, as indicated in FIG. 7 by the signal line with the reference numeral 90. Additional information is therefore provided in addition to the absolute weight force data (part weight data). (The absolute weight data of the weight force sensors FL, FR and BL are part weight data; as mentioned above, the weight information and also the seat occupation information has to be determined from the weight data of a plurality of weight force sensors.)

It can be determined by means of the time analysis device 78 whether a person or an object is positioned on the seat 12. In the time analysis, the heartbeat and/or breathing of a seat occupant is visible as a corresponding frequency in the order of magnitude of 1 Hz. Furthermore, seat occupation information can be derived by means of the corresponding time information, i.e. frequency information. If, for example, a single weight force sensor has a pronounced physiological frequency in the frequency spectrum, this indicates that a seat occupant with his centre of gravity is closer to this weight force sensor than to other weight force sensors.

Usable additional information can be determined by means of the time analysis device 78, in particular, in a sensor system 10 which comprises less than four weight force sensors 22 implemented as hardware.

Furthermore, it is also possible to carry out a plausibility check by means of the time analysis data provided. It can be checked whether the weight data provided are plausible to optionally emit a warning signal.

It may be provided, in this case, that the time analysis device 78 comprises a switching device 92. This switching device can be configured as an “either/or” switch or as an “and/or” switch.

The switching device 92 means that it is possible, for example, to also provide the unit 34 with time analysis data (in particular frequency data) in order to be able to use these in the simulation of a virtual sensor.

Furthermore, it is possible, as an alternative or additionally, to provide the data processing device 32 with time analysis data by means of the switching device 92. This can be taken into account when taking into account the calculation of the centre of gravity of the measured weight force signals or during the summation.

Furthermore, it is possible, as an alternative or additionally, to provide the plausibility checking device 70 with frequency data by means of the switching device 92.

In the method according to the invention, in addition to the absolute value of the measured weight force signals, which characterises a part weight of the seat occupant, the time course is evaluated, in particular in conjunction with physiological frequencies. The additional information obtained can be used for checking weight force sensors implemented as hardware. Furthermore, the time analysis data obtained can be used to classify the seat occupation. Furthermore, it is possible to use the time analysis data when calculating the total weight. The time analysis can easily be implemented as software.

The solution according to the invention means that it is possible to distinguish whether the seat occupant is an adult or a child or if there is a non-living load on the seat 10. Using the time analysis data, a belt force sensor (BTS) can then be dispensed with. This is advantageous, for example, in applications, in which the belt force sensor cannot be fastened to an upper seat frame.

1. A sensor system for determining at least one the weight and position of a seat occupant, comprising:
at least two spaced-apart weight force sensors, which provide measured weight force signals; and
a control device, which generates a signal characterising at least one the weight and the position of a seat occupant on the basis of the measured weight force signals;
wherein the control device has a time analysis device, by means of which the time course of a measured weight force signal of at least one weight force sensor is adapted to be analysed and which provides time analysis data.

2. The sensor system according to claim 1, wherein the time analysis device has a frequency converter, which generates a frequency spectrum for a measured weight force signal.

3. The sensor system according to claim 1, wherein the time analysis device comprises a filter which filters out frequencies above a limit frequency.

4. The sensor system according to claim 3, wherein the limit frequency is at most 30 Hz.

5. The sensor system according to claim 1, wherein the presence of physiological frequencies in the measured weight force signal of the at least one weight force sensor is adapted to be checked with the time analysis device.

6. The sensor system according to claim 1, wherein the control device comprises a classification device, which provides seat occupation classification data with regard to at least one the weight and position of a seat occupant.

7. The sensor system according to claim 6, wherein the time analysis device is connected to the classification device and provides the classification device with time analysis data.

8. The sensor system according to claim 7, wherein the classification device takes into account time analysis data in the determination of seat occupation classification data.

9. The sensor system according to claim 1, wherein the control device comprises a plausibility checking device, to which time analysis data are provided.

10. The sensor system according to claim 1, comprising a data processing device which combines weight force signals of a plurality of weight force sensors.

11. The sensor system according to claim 10, wherein there is associated with the data processing device at least one filter device, by means of which the data processing device is adapted to be provided with weight force signals which are time-independent or at most change slowly with respect to time.

12. The sensor system according to claim 10, wherein the time analysis device provides the data processing device with time analysis data.

13. The sensor system according to claim 1, wherein the time analysis device comprises a switching device, by means of which a switch is adapted to be made as to whether at least one of a classification device, a plausibility checking device, a data processing device, and one or more virtual weight force sensors are to be provided with time analysis data.

14. The sensor system according to claim 1, wherein at least one virtual weight force sensor is provided, the virtual weight force signals of which are determined on the basis of measured weight force signals of at least two weight force sensors, the position of a seat occupant being determined on the basis of measured weight force signals and virtual weight force signals.

15. The sensor system according to claim 14, wherein the at least one virtual weight force sensor is implemented as software in the control device.

16. The sensor system according to claim 14, wherein the at least one virtual weight force sensor replaces or supplements a hardware weight force sensor.

17. The sensor system according to claim 14, wherein the at least one virtual weight force sensor is provided with time analysis data.

18. The sensor system according to claim 14, wherein the weight force sensors are arranged on the corners of a polygon, and the at least one virtual weight force sensor is associated with a polygon corner.

19. The sensor system according to claim 14, comprising a data processing device for calculating the spatial centre of gravity of the measured weight force signals.

20. The sensor system according to claim 19, wherein the sum of the measured weight force signals and the virtual weight force signals can be determined by the data processing device.

21. A seat, which is provided with a sensor system for determining at least one of the weight and position of a seat occupant, comprising:
at least two spaced-apart weight force sensors, which provide measured weight force signals; and
a control device, which generates a signal characterising at least one of the weight and the position of a seat occupant on the basis of the measured weight force signals;
wherein the control device has a time analysis device, by means of which the time course of a measured weight force signal of at least one weight force sensor can be analysed and which provides time analysis data.

22. The seat according to claim 21, wherein the sensor system is arranged on a seat face.

23. A method for determining at least one of the weight and position of a seat occupant, in which measured weight force signals from at least two spaced-apart weight force sensors are evaluated,
wherein in addition to the evaluation of measured weight force variables, a time analysis of measured weight force signals is carried out and time analysis data are taken into account in calculating at least one of the weight and position of a seat occupant, and the measured weight force signals are checked for plausibility with the aid of the time analysis data.

24. The method according to claim 23, wherein a frequency analysis is carried out with respect to physiological frequencies.

25. The method according to claim 23, wherein a frequency analysis is carried out with respect to frequencies below a limit frequency.

26. The method according to claim 25, wherein the limit frequency is at most 30 Hz.

27. The method according to claim 23, wherein virtual weight force signals are calculated from measured weight force signals, at least one virtual weight force sensor being simulated by virtual weight force signals.

28. The method according to claim 27, wherein at least one of the weight and the position of a seat occupant is calculated using the measured weight force signals and the virtual weight force signals.

29. The method according to claim 23, wherein a seat occupation classification is carried out with the aid of the time analysis data.

30. The method according to claim 27, wherein the time analysis data are used to simulate the at least one virtual weight force sensor.

31. The method according to claim 23, wherein the measured weight force signals are checked for plausibility by means of the time analysis data.
